(19) United States
(12) Patent Application Publication
(10) Pub. No.: US 2008/0059506 A1
(43) Pub. Date: Mar. 6, 2008

(54) METHOD, SYSTEM AND SCHEMA FOR BUILDING A HIERARCHICAL MODEL SCHEMA DEFINITION FROM A FLAT MODEL DEFINITION

(76) Inventors: Suman Kumar Kalia, Maple (CA); Stephen M. Hanson, Romsey (GB); Dominic J. Storey, Eastleigh (GB)

Correspondence Address: HOFFMAN WARNICK & DALESSANDRO LLC, 75 STATE ST, 14TH FLOOR, ALBANY, NY, 12207, US

(21) Appl. No.: 11/470,146

(22) Filed: Sep. 5, 2006

(51) Int. Cl. G06F 7/76

(52) U.S. Cl. 707/102

(57) ABSTRACT

A system, method and schema for building a hierarchical model schema definition from a flat model definition are disclosed. The system, method and schema identifies a local parent element and type definition pertaining to a hierarchical loop containing the element identifier data element, a parent identifier segment if a parent exists, a segment for the hierarchical loop level code of the subject element and a child identifier segment if a child element exists. It then moves the contents of the type definition to a global group and then creates global element definitions for element references in the related hierarchical data element and, for each value in an hierarchical loop level code element, creates a local child element of complex type and adding the local child element to the hierarchical loop complex.

### CROSS-REFERENCE TO RELATED APPLICATIONS

This application is related in some aspects to the commonly owned and co-pending application entitled “A Scalable Logical Model for EDI and System and Method for Creating, Mapping and Parsing EDI Messages”, filed Sep. 5, 2006, assigned attorney docket number CA920060033US1, and assigned serial number (to be provided), the entire contents of which are herein incorporated by reference. This application also is related in some aspects to the commonly owned and co-pending application entitled “Message Validation Model”, filed Sep. 5, 2006, assigned attorney docket number CA920060034US1, and assigned serial number (to be provided), the entire contents of which are herein incorporated by reference. This application is also related in some aspects to commonly owned, and co-pending published patent application number US 2004-0103071 A1, entitled “Meta-Model for Associating Multiple Physical Representations of Logically Equivalent Entities in Messaging and Other Applications”, filed Nov. 6, 2003, and published May 27, 2004, the entire contents of which are herein incorporated by reference.

### FIELD OF THE INVENTION

The present invention relates to moving from a flat model to a hierarchical model, and more particularly to building hierarchical data from a from a flat file definition. More specifically, this invention relates generally to the field of creating, analyzing and parsing electronic documents, and to a method, system and software for creating, building, receiving and analyzing an Electronic Data Interchange (EDI) document by hierarchically representing the EDI document in a storage medium. The invention also provides a means for creating an EDI document using new hierarchical constructs, and persisting the EDI document to a storage medium.

### BACKGROUND OF THE INVENTION

In large enterprises, there is often a need to share data and generally intercommunicate between many operating systems, platforms, and applications. A stumbling block to the goal of intercommunication is the fact that each different computer system may represent messages using a different message protocol or physical “wire format” (i.e. manner of laying out a message on the wire). The data transfer can be for a sale, an exchange, or any of the other various types of data transfers related to business transactions. For example, many purchase orders, invoices, and advance shipping notices are sent to and from trading partners over the course of a month or so, whereby these documents are transmitted and received by way of an EDI system provided at each trading partner.

EDI standards were developed over many years to facilitate the exchange of business data and conduct transactions among trading partners. The standards defined a set of commonly used logical element definitions in business transactions and described how to build higher level messages by composing these logical element definitions. The standards also describe the physical representation of EDI messages on the wire. These logical element definitions are called segments in EDI terminology and an EDI message can contain a set of segments.

For background, Electronic Data Interchange (EDI) is the computer-to-computer exchange of choice for structured information, by agreed message standards, from one computer application to another by electronic means and with a minimum of human intervention. In common usage, EDI is understood to mean specific interchange methods agreed upon by national or international standards bodies for the transfer of business transaction data, with one typical application being the automated purchase of goods and services.

Despite being relatively unheralded, in this era of technologies such as XML services, the Internet and the World Wide Web, EDI is still the data format used by the vast majority of electronic commerce transactions in the world. EDI was developed to support business-to-business internal communication, and it has been around approximately for the last twenty-five years. However, EDI is also relevant for company-to-supplier retailer relationships, where the company can be an end-user, a manufacturer, a service organization such as a hospital or a hotel, a governmental organization or a virtual organization.

EDI can be viewed as a set of messages developed for business-to-business communication of electronic data. It works by providing a collection of standard message formats and element dictionaries for businesses to exchange data via any electronic messaging service, and is characterized by standardized electronic formats for exchanging business data. Thus, EDI is conveniently used in electronic commerce for the exchange of documents between trading partners in a transaction.

Companies sending and/or receiving EDI data are required to ensure that they have tailored software programs that map between two types of data, one being EDI data and the other being data in a company's internal system formats. Such mapping is a complex process that requires extensive resources and is time consuming.

The basic unit of information in an EDI document is a data element. An example of an EDI document is an invoice, a purchase order, or an advance shipping notice (ASN). Each item in the EDI invoice, purchase order or ASN is representative of a data element. Each data element may represent a singular fact, such as a price, product, model number, and so forth. A string of data elements can be grouped together, and is called a data segment, or segment. There can be several data segments per document or message, each having its own use. Each data segment is used for defining a specific item. In addition, an EDI document may include functional groups and transaction sets. Furthermore, an EDI document generally includes addressing information specific to a trading partner.

Translators are used to provide the mapping necessary to read EDI documents. Translators read and parse documents in an EDI format, to generate visual documents for data entry, to translate the EDI to an in-house format, or to change status of the data within an application itself.

An EDI interchange is read from a flat file, and then serially processed by a translator. The interchange is the “envelope” by which one or more electronic documents are carried as they traverse the EDI from one company to another company. For conventional EDI systems, there is no convenient way to hierarchically represent an EDI interchange or an EDI document in a model, so as to allow third party applications to traverse, fetch, and/or set specific segment, element or sub-element data within an EDI interchange or an EDI document.

However, there is a problem with EDI. Parent/child types of relationships are quite prevalent among messages in a number of application domains, that is, some documents or messages are very related to other documents or messages. But, with the “flat” file format of EDI, it cannot handle parent/child (hierarchical) relationships in a manner that suits the sender or receiver so that the sender cannot indicate that a message is related to another and the receiver cannot determine the same. The problem is that the EDI format is flat—thereby limiting the capability of hierarchical interpretation.

What is needed is a method and system for building a hierarchical model schema definition, which may be pulled from the flat file and used to build a hierarchical file needed for business transactions.

### SUMMARY OF THE INVENTION

The system, method and schema provide a hierarchical model schema definition from a flat model definition so that hierarchical data within flat files may be pulled from the flat files and used to build a hierarchical representation needed for business transactions.

The invention is to exploit HL segments (defined in EDI segments) within the flat model definition called the Hierarchical Loop (HL) to describe relationships among messages in a number of application domains. The HL segment, when used, is parsed and noted as being a hierarchical structure. The HL segment is used to describe the relationships among EDI messages at runtime. This is especially important as many EDI messages have relationships to one another.

Regarding the structure of the segment, the HL segment is typically the very first segment in the EDI message details group and it only needs to present the EDI domains messages having a need to build parent/child relationships.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an example embodiment of this invention:

FIG. 1 is a block diagram showing the general components of a computer system that can be used to run an EDI Document Object Model, or EDI DOM, (hereinafter also referred to as “model”), according to an embodiment of the present invention;

FIG. 2 is a block diagram showing a hierarchical memory representation of an EDI document that is provided by way of an EDI DOM according to an embodiment of the present invention;

FIG. 2A is a block diagram of an EDI Segment according to an embodiment of the present invention;

FIG. 2B is a block diagram of a sample transaction, which requires the hierarchical structure according to an embodiment of the present invention;

FIG. 3 is a block diagram of an IBM 856 Message Instance that illustrates an EDI Segment for a transaction according to an embodiment of the present invention;

FIG. 4 is an intended logical model schema definition for an IBM 856 Message Definition of an EDI Segment according to an embodiment of the present invention; and

FIG. 5 is an intended logical model schema definition for an IBM 856 Message Definition of an EDI Segment defining a sample transaction according to an embodiment of the present invention.

### DETAILED DESCRIPTION OF THE INVENTION

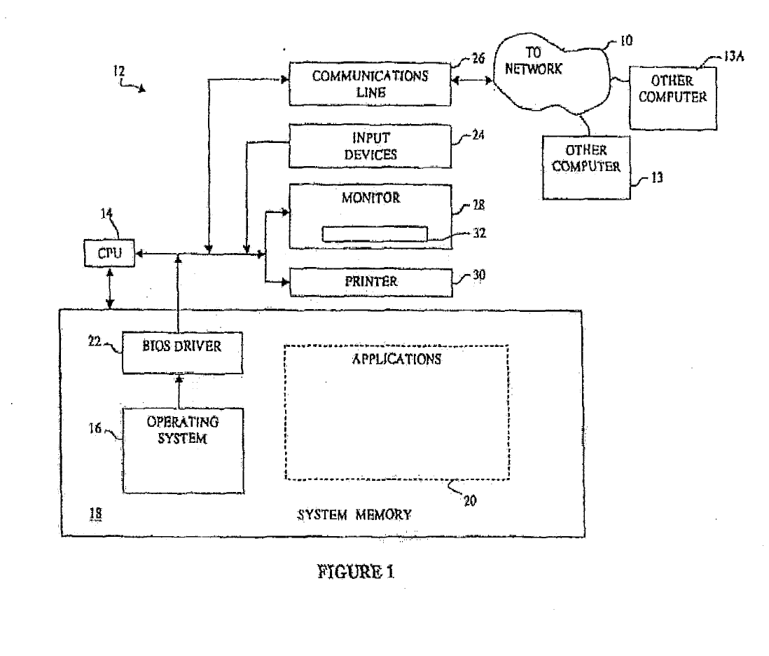

With reference to the accompanying drawings, a detailed description of the present invention will be provided. FIG. 1 is a block diagram showing the components of a general-purpose computer system 12 connected to an electronic network 10, such as a computer network. The computer network 10 can also be a public network, such as the Internet or Metropolitan Area Network (MAN), or other private network, such as a corporate Local Area Network (LAN) or Wide Area Network (WAN), or a virtual private network (VPN). As shown in FIG. 1, the computer system 12 includes a central processing unit (CPU) 14 connected to a system memory 18. The system memory 18 typically contains an operating system 16, a BIOS (basic input/output system) driver 22, and application programs 20. In addition, the computer system 12 contains input devices 24 such as a mouse and a keyboard 32, and output devices such as a printer 30 and a display monitor 28.

The computer system generally includes a communications interface 26, such as an Ethernet card, to communicate to the electronic network 10. Other computer systems 13 and 13A may also be connected to the electronic network 10. One skilled in the art would recognize that the above system describes the typical components of a computer system connected to an electronic network. It should be appreciated that many other similar configurations are within the abilities of one skilled in the art and all of these configurations could be used with the methods of the present invention.

In addition, one skilled in the art would recognize that the “computer” implemented invention described further herein may include components that are not computers per se but include devices such as Internet appliances and Programmable Logic Controllers (PLCs) that may be used to provide one or more of the functionalities discussed herein. Furthermore, “electronic” networks are generically used to refer to the communications network connecting the processing sites of the present invention, including implementation by using optical or other equivalent technologies.

One skilled in the art would recognize that other system configurations and data structures and electronic/data signals could be provided to implement the functionality of the present invention. All such configurations and data structures are considered to be within the scope of the present invention.

The present invention is directed to an EDI Document Object Model, or EDI DOM, (hereinafter also referred to as “model”), which allows for an electronic interchange document to be represented as an in-memory hierarchical model based upon a set of enumerated values specified in the EDI document. With such a model, various types of client software and applications can be utilized in order to manipulate, extract, and set segment, element, and/or sub-element information stored within the model as well as create matching schema (meta message definition). This allows one to readily generate an interchange or document from the model at run-time that may be mapped/transformed to another structure. That is, a user is able to parse and pull particular information from a first electronic document, whereby that information may correspond to segment data, element data or sub-element data, and pull that information into a second electronic document in the same EDI format or in another EDI format.

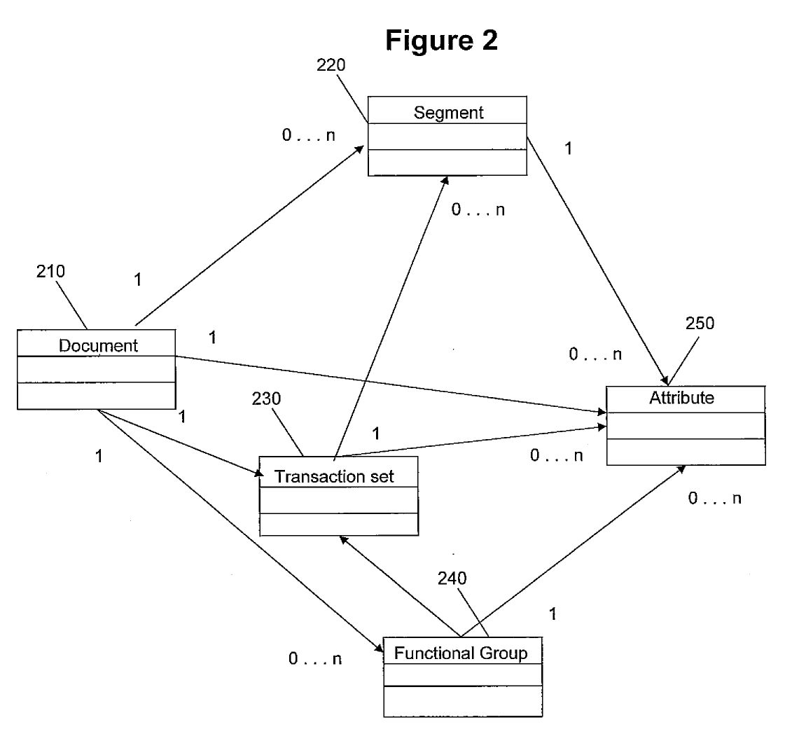

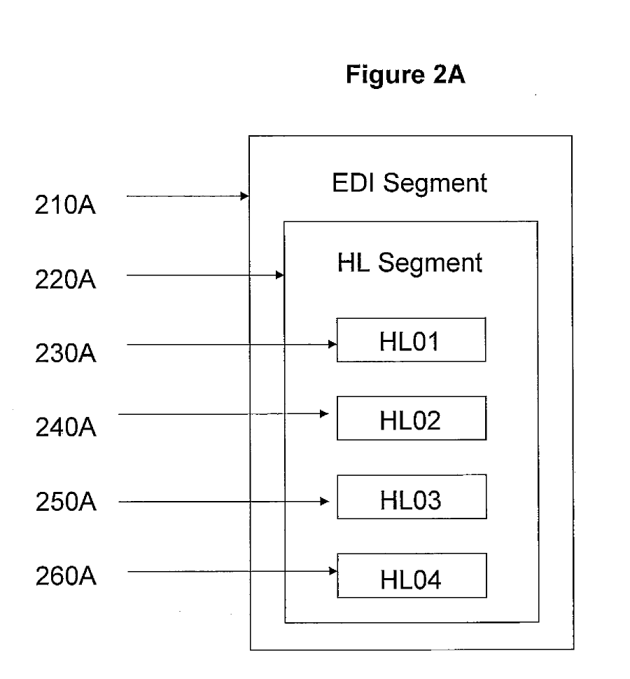

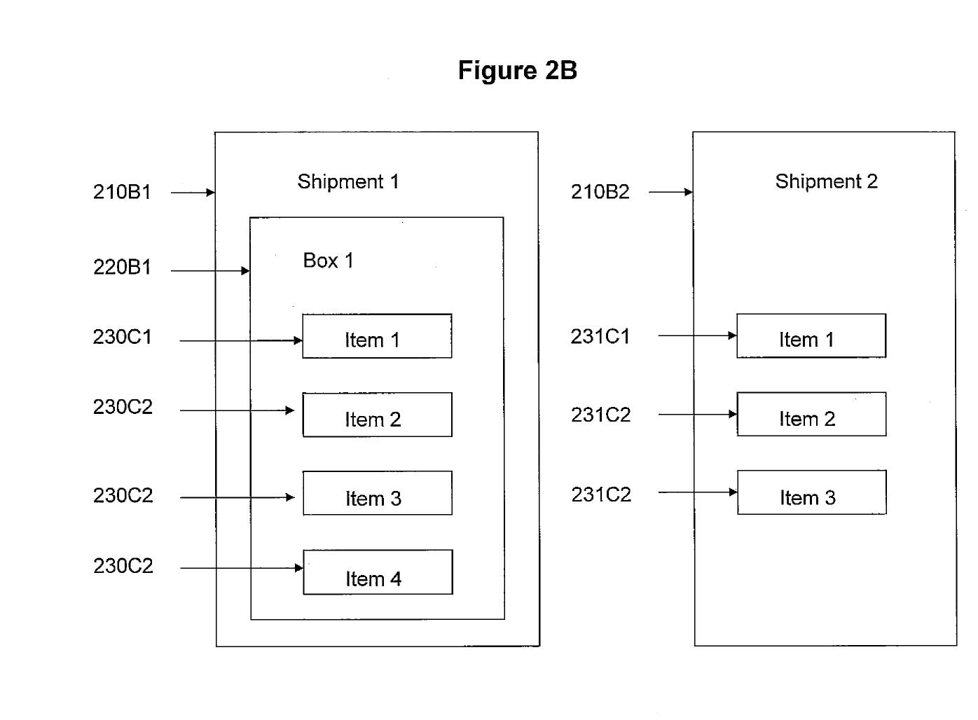

The EDI DOM contains the classes or objects that serve as a container for EDI document elements. The overall object model is shown in FIG. 2, and includes a Document class (or object), a Segment class (or object), a Functional Group class (or object), a Transaction Set class (or object), and a Data Element (or object).

EDI documents are represented as a collection of data elements, segments, functional groups and transaction sets. The EDI DOM according to the present invention takes advantage of this type of representation, and stores that information as objects in a hierarchical manner in a memory, to allow specific data to be retrieved from an electronic document according to those representations.

Referring now to FIG. 2, the Document class 210 represents an EDI document as a collection of data elements, segments, functional groups, and transaction sets. The Document class 210 is the root node of the DOM-style representation of an EDI document according to the invention, whereby a document is represented in the EDI DOM as a collection of the fundamental entities of the document.

The fundamental entities of an EDI document, which is represented by a Document node 210 in FIG. 2, are: 1) a single interchange envelope by which the EDI document is sent from one company to another company; 2) zero or more interchange control segments, as indicated by zero or more interchange control segment nodes 220; 3) zero or more transaction sets contained within a functional group, as indicated by zero or more transaction set nodes 230; and 4) zero or more functional groups containing one or more transaction sets, as indicated by zero or more functional group nodes 240. The data for each node is stored in memory, whereby data for a node can be retrieved from the memory in a manner known to those skilled in the art with respect to memory data retrieval. Transaction set nodes can occur in an EDI document apart from their inclusion in a functional group. In other words, hierarchically speaking, an EDI document can contain zero or more “independent” transaction sets plus zero or more functional groups, which contain one or more transaction sets.

In the present invention, data of an EDI document is stored as new fields within the HL (hierarchical loop) segment according to the hierarchical model shown in FIG. 2.

FIG. 2A illustrates the data elements within the HL segment. The EDI message 210A has an HL segment 220A. The HL segment 220A describes relationships between messages at runtime. The HL segment is typically the very first segment in the EDI message details group and it only needs to be present in EDI domain messages having a need to build parent/child relationships.

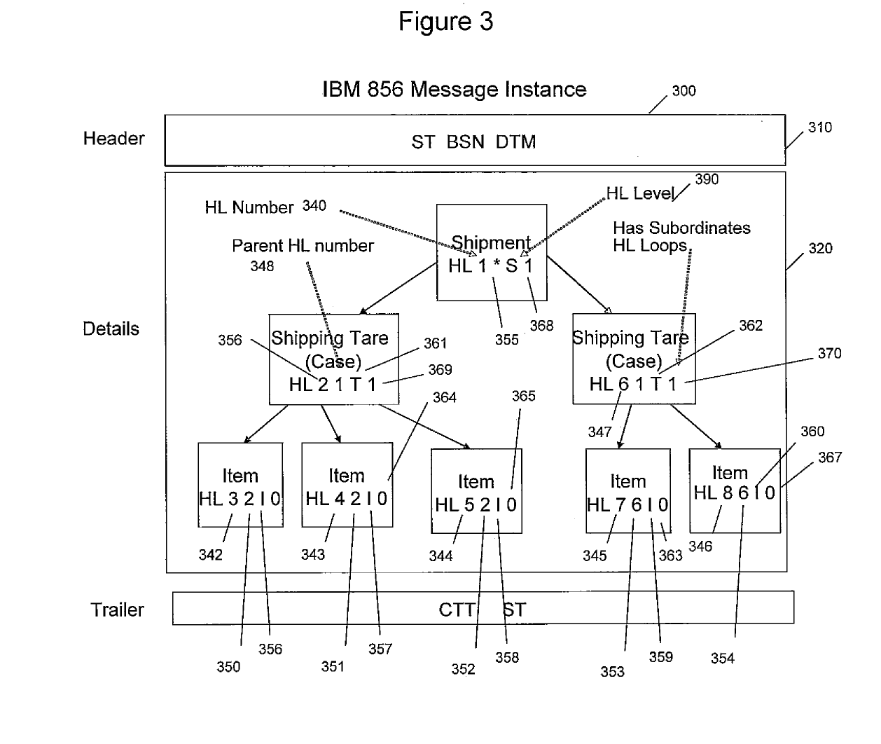

The HL segment comprises four elements: HL01 230A; HL02 240A; HL03 250A; and HL04 240A. These four elements have the following definitions HL01—Hierarchical element ID (“element identifier Data element”)
This ID number is used to identify the present record. Every record in the repeating structure has a unique ID. E.g., if present record is the first record, the Hierarchical element ID may be HL01=1. This is seen as HL Number HL01 340 in FIG. 3, which is a representation of a sample IBM 856 Message Instance. It can also been seen as HL numbers 341-347 in FIG. 3.
HL02—Hierarchical Parent ID Number (“parent identifier data element”)
   This ID number is used to identify which record is parent of the present record—if the present record has a parent. E.g., if the present record has a parent record with the Hierarchical element ID of HL01=6, then the Hierarchical Parent ID Number would be HL02=6. This is seen as HL Number HL02 353 in FIG. 3 of the sample IBM 856 Message Instance. It can also been seen as HL numbers 348-355 in FIG. 3.
HL03—Hierarchical level code (“hierarchical loop level code Data element”)
   This code identifies the record type of the present record.
   There can be many different types of record types. Examples of record types of the IBM—856 message (the preferred embodiment) are as follows:
      I—Item (HL03 numbers 356-360 in FIG. 3)
      S—Shipment (HL03 number 390 in FIG. 3)
      T—Shipping Tare (Case or Box) (HL03 numbers 361, 362 in FIG. 3)
   E.g., if the present record is a record for an Item, it would have a Hierarchical Level Code of HL03=1. If the present record is a record for a Shipment, it would have a Hierarchical Level Code of HL03=S. If the present record is a record for Shipping Tare, it would have a Hierarchical Level Code of HL03=T.
HL04—Hierarchical child code (“child exists indicator data element”)
   This code is used to identify whether the present record has children (one or more “child elements”) or subordinates in this hierarchical structure. The code is as follows:
      0—The present record has no subordinates HL segments in this Hierarchical structure. (HL04 numbers 363-367 in FIG. 3)
      1—The present record has additional subordinates HL segments in this Hierarchical structure. (HL04 numbers 368-370 in FIG. 3)
   E.g., if the present record has no children HL segments in this Hierarchical structure, its Hierarchical child code would be HL04=0. Likewise, if the present record has one or more children HL segments in this Hierarchical structure, its Hierarchical child code would be HL04=1.

In a conventional EDI electronic document, the document entity, the segment entity or entities, the transaction set entity or entities, and the functional group entity or entities are stored in a sequential manner in the electronic document. Headers (see Header 310 in FIG. 3) and trailers (see Trailer 330 in FIG. 3) are provided between these entities in the electronic document to provide delimiters for the different entities of the electronic document, as well as to provide data element or record information that is related to the type of information stored for each entity. The data element or record information that is related to the type of information stored for each entity is called the details (see Details 320 in FIG. 3).

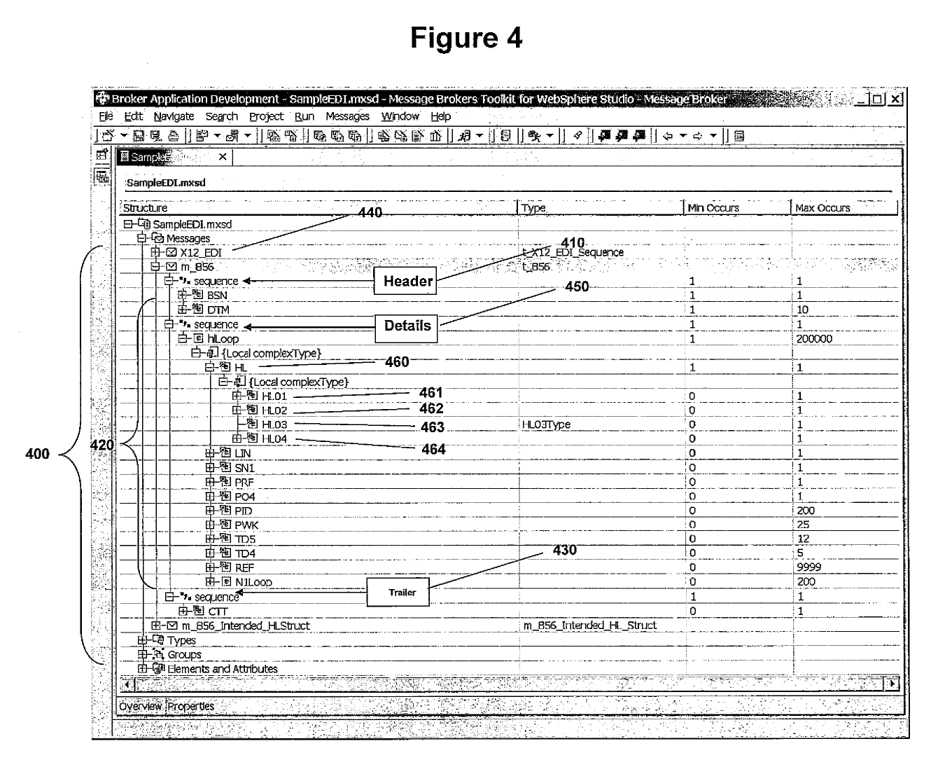

This can be seen more clearly in FIG. 4, which is a sample EDI hierarchical structure 400. Header 410 and Trailer 430 delimit EDI hierarchical message m_856 420 from another EDI message. EDI hierarchical Message Details 450 provide the data element or record information that is related to the type of information stored in the EDI hierarchical message m_856 420.

Within the EDI hierarchical message m 856 420, and more particularly, within the EDI hierarchical Message Details 450 is the Hierarchical Loop segment 460. Within the Hierarchical Loop segment 460 are the above-referenced HL01 461, HL02 462, HL03 463, and HL04 464.

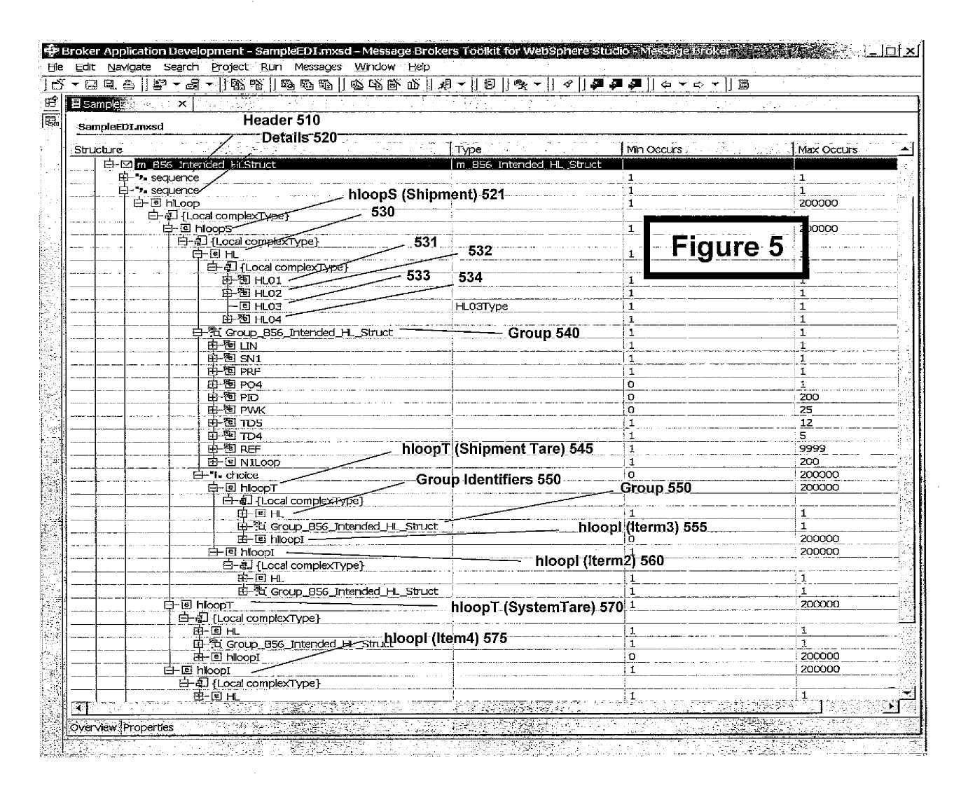

This is also shown in FIG. 5 having header 510, details 520, shipment element (item 1) 521, shipment element ID 531, shipment parent identifier element 532, shipment element type 533, shipment element child code 534 and group 540. Shipment element 521 has a child shipment tare 545, which has its own group identifiers 546 and group 550. Shipment element 521 is the parent of shipment tare element 545 and shipment item element (item 2) 560 while shipment tare element 545 is the parent of shipment item element (item 3) 555. Shipment element is parent also to System Tare element 570 and shipment item (item 5) while System Tare element 570 is parent to shipment element item (item 4) 575. Block diagram of FIG. 2B shows a parent/child relationship in more simple form where Item 1 230C1, Item 2 230C2, Item 3 230C3, and Item 4 230C4 are children of Box1 220B1. Likewise, Item 1 231C1, Item 2 231C2, and Item 3 231C3are children of Shipment 2 210B2. Similarly, Box1 220B1 is a child of Shipment 210B1. Their respective HL numbers denotes these relationships.

Described below is the algorithm creating intended logical model schema definition.

1. Identify the local element pertaining to hierarchical loop in the flat logical model schema and its complex type definition, say t1. In the example noted in FIG. 4 this element is hilltop.

2. Create a global group say g1 and move the contents of complex type t1 to this group except the HL segment. For the example in FIG. 5, groupGroup_{—}858_Intended_HL_Struct. Create Global element definitions for element references defined in HL segment, i.e., HL01, HL02, HL03 and HL04.

3. For each enumeration value defined in the HL03 element of the HL segment:
a. Create a local element of anonymous complex type and add these elements to hierarchical loop element complex type t1. In example of FIG. 5, such local elements are hIloopS 521, hIloopT 570 and hIloopI 580.
b. Change the composition of hierarchical loop element complex type to choice.

4. Ask user regarding the hierarchy to be created between the record types defined in HL03 element. E.g., Shipment (S) is the parent of Shipment T are (T) and Shipment Tare (T) is the parent of Item (I).

5. For each local element created in Step 3a, do the following:

6. For the selected local element, get its complex type say t2.

7. Create a local element with name HL of anonymous complex type
a. Add following to the HL element anonymous complex type
   i.Element references to HL01, HL02 elements
   ii.Local element HL03 of anonymous simple type restricted to a set of enumerations defined originally for HL03 element of HL segment found in step 2.
   iii.Element reference in HL04 element
b. Add HL local element to the complex type t2.

8. Add a group reference in the complex type t2 pointing to the global group created in Step 2.

9. If the selected element in Step 6 is immediate parent of more than one record types (e.g., Shipment (S) can be immediate parent of Shipment Tare (T) and of Item (I).
a. Add to complex type t2 a local choice group with minOccurs set to 0 and maxOccurs set to maxOccurs specified in the HL element from Step 1.
b. Create local elements of anonymous complex type for the enumerations pertaining to immediate children and add them to the local choice group.
c. For each local element, repeat Step 6 through 9.

10. If the selected element in Step 6 is immediate parent of just one record type
a. Create local elements of anonymous complex type for the enumerations pertaining to immediate child. On the local element, set minOccurs to 0 and maxOccurs to maxOccurs specified in the hierarchical loop element from Step 1.
b. Repeat Steps 6 through 9.

Using the intended hierarchical logical model definition built at tooling time, users can use the mapping tools to map the hierarchal message instance to another structure or generate code at tooling time for manipulating the hierarchal structure etc.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/Output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for building a hierarchical model schema definition from a flat model definition, comprising the steps of:
(a) identifying a local parent element and type definition pertaining to a hierarchical loop containing the element identifier segment, a parent identifier segment if a parent exists, a segment for the hierarchical loop level code of the subject element and a child identifier segment if a child element exists;
(b) moving the contents of the type definition to a global group;
(c) creating global element definitions for element references in the related hierarchical loop segment;
(d) for each value in an hierarchical loop level code element, creating a local child element of complex type and adding the local child element to the hierarchical loop complex;
(e) receiving input from a user defining the hierarchy to be created between record types defined in the hierarchical loop level code element;
(f) for each local element, identifying its complex type, creating a local element of anonymous complex type, adding element references to the element identifier segment and the parent identifier segment, adding a new local element of anonymous simple type, and adding the new local element to the complex type element;
(g) adding an element reference to child exists indicator element; and
(h) adding a group reference to the complex type pointing to the global group.

2. A method according to claim 1, further comprising the steps of:
(i) if each local element is an immediate parent of another element, adding to the complex type a local choice group with minimum occurrences (minOccurs) set to zero (0) and maximum occurrences (maxOccurs) set to the setting specified on the local parent element;
(j) creating local elements of anonymous complex type for each enumeration pertaining to immediate children of the local parent element, and
(k) for each local element so created, performing step (f) and step (g) of claim 1; and
(l) creating local elements of anonymous complex type for each enumeration pertaining to each immediate child element, and for each local element so created, performing step (f) and step (g) of claim 1.

3. A system for building a hierarchical model schema definition from a flat model definition, comprising the steps of:
an identifier to identify a local parent element and type definition pertaining to a hierarchical loop containing the element identifier data element, a parent identifier data element if a child exists, a data element for the hierarchical loop level code of the subject element and a child identifier data element if a child element exists;
a mover for moving the contents of the type definition to a global group;
a creator for creating global element definitions for element references in the related hierarchical loop segment and for creating a local child element of complex type and adding the local child element to the hierarchical loop complex for each value in an hierarchical loop level code element;
a receiver for receiving input from a user defining the hierarchy to be created between record types defined in the hierarchical loop level code element;
an identifier for identifying, for each local element, its complex type, and for creating a local element of anonymous complex type, and for adding element references to the element identifier segment and the parent identifier segment, and for adding a new local element of anonymous simple type, and for adding the new local element to the complex type element; and
an adder for adding a group reference to the complex type pointing to the global group.

4. A system according to claim 3, further comprising:
an adder for, if each local element is an immediate parent of another element, adding to the complex type a local choice group with minimum occurrences (minOccurs) set to zero (0) and maximum occurrences (maxOccurs) set to the setting specified on the local parent element, for creating local elements of anonymous complex type for each enumeration pertaining to immediate children of the parent local element, and for, for each local element so created, for each local element, identifying its complex type, for creating a local element of anonymous complex type, for adding element references to the element identifier segment and the parent identifier segment, for adding a new local element of anonymous simple type, adding a group reference pointing to global group, and for adding the new local element to the complex type element and for creating local elements of anonymous complex type for each enumeration pertaining to each immediate child element, and for each local element so created, for each local element, for identifying its complex type, for creating a local element of anonymous complex type, for adding element references to the element identifier segment and the parent identifier segment, for adding a new local element of anonymous simple type, for adding the new local element to the complex type element and adding a group reference to the complex type pointing to the global group.

5. An algorithm for creating logical model schema definition for an EDI message comprising the steps of:
(1) identifying the local element pertaining to hierarchical loop in the flat logical model schema and its complex type definition t1;
(2) creating a global group g1 and moving the contents of complex type t1 to group g1 except an HL segment and creating Global element definitions for element references (HL01, HL02, HL03 and HL04) defined in the HL segment;
(3) for each enumeration value defined in the HL03 element of the HL segment:
(a) creating a local element of anonymous complex type and add these elements to hierarchical loop element complex type t1;
(b) changing the composition of hierarchical loop element complex type to choice;
(4) obtaining from a user the hierarchy, or parent/child relationships, to be created between the record types defined in HL03 element;.
(5) for each local element created in Step 3a, performing the following steps:
(6) for the selected local element, obtaining its complex type t2;
(7) creating a local element HL of anonymous complex type;
(a) adding to the HL element anonymous complex type:
(i) element references to HL01, HL02 elements;
(ii) local element HL03 of anonymous simple type restricted to a set of enumerations defined originally for HL03 element of HL segment found in step 2; and
(iii) element reference in HL04 element; and
(b) adding HL local element to the complex type t2;
(8) adding a group reference in the complex type t2 pointing to the global group created in Step 2;
(9) if the selected element in Step 6 is an immediate parent of more than one record types performing the following steps:
(a) adding to complex type t2 a local choice group with minimum occurrences (minOccurs) set to 0 and maximum occurrences (maxOccurs) set to the value of maxOccurs specified in the HL element from Step 1;
(b) creating local elements of anonymous complex type for the enumerations pertaining to immediate children and adding them to the local choice group;
(c) for each local element, repeating Step 6 through 9;
(10) if the selected element in Step 6 is an immediate parent of just one record type performing the following steps:
(a) creating local elements of anonymous complex type for the enumerations pertaining to the immediate child and, on the local element, setting minOccurs to 0 and setting maxOccurs to the value of maxOccurs specified in the hierarchical loop element from Step 1; and
(11) repeating Steps 6 through 9.

6. The algorithm of claim 5, wherein the record types of Step 4 are Shipment (S), Shipment Tare (T) and Item (I).
